(19) United States
(12) Patent Application Publication
(10) Pub. No.: US 2008/0165528 A1
(43) Pub. Date: Jul. 10, 2008

(54) Ceiling light emitting assembly

(75) Inventors: Ming Lu, Sijhih City (TW); Kai Chiu Wu, Tsuen Wan (HK); Lei Shi, Kowloon (HK); Chak Hau Pang, Fanling (HK)

Correspondence Address: BUCHANAN, INGERSOLL & ROONEY PC, POST OFFICE BOX 1404, ALEXANDRIA, VA, 22313-1404, US

(73) Assignee: Hong Kong Applied Science and Technology Research Institute Company Limited, Shatin (HK)

(21) Appl. No.: 11/806,929

(22) Filed: Jun. 5, 2007

(30) Foreign Application Priority Data
Jan. 5, 2007 (HK) 07100218.9

(51) Int. Cl. F21V 29/00; F21S 8/04; F21V 7/00

(52) U.S. Cl. 362/147; 362/235; 362/294; 362/373

(57) ABSTRACT

A ceiling light emitting assembly includes a first plate with at least a first light emitting source thereon for emission of light. When in use, the first plate extends at a first angle to a substantially horizontal direction.

### FIELD OF THE INVENTION

The invention relates generally to light emitting assemblies for ceilings, and more particularly to light emitting assemblies with heat dissipation structures.

### BACKGROUND OF THE INVENTION

A light emitting assembly for ceilings can generally have a large horizontal planar substrate or plate with a plurality of light emitting sources which are mounted on the plate and which generate heat when emitting lights.

It is often desirable to remove generated heat so as to lower the temperature of the light emitting sources and the plate for reasons such as maintaining the light emitting sources within their optimal thermal operating conditions. Heat sinks or heat pipes can be used for heat dissipation purpose. However, such an extra mechanism may make the light emitting assembly unnecessarily bulky.

Alternatively, heat dissipation can be achieved through natural convention. A conventional ceiling light emitting assembly is shown in FIG. 1, having a large horizontal planar plate 101 with light emitting sources 103 thereon. In this design, a substantial amount of heat generated by the light emitting sources 103 is removed by the air 105 flowing substantially vertically and upwards towards the plate 101 and then being redirected horizontally by the plate 101 and passing the light emitting sources 103. In addition, air may flow passing the edge of the plate 101 and remove certain amount of heat from the plate, as indicated by arrow 107. A skilled person in the art will appreciate that in such a conventional design, the horizontal plate 100 may exert a relatively high resistance to the air 105 flowing vertically and upwards towards the plate 101 and then horizontally passing the light emitting sources 103, and the relatively high air flow resistance may adversely affect the efficiency of heat dissipation through natural convection.

It is an object of the present invention to provide a light emitting assembly with improved heat dissipation characteristics.

### SUMMARY OF THE INVENTION

According to an aspect of the present invention, a ceiling light emitting assembly includes a first plate having at least a first light emitting source thereon for emission of light. When in use, the first plate extends at a first angle to a substantially horizontal direction for reducing resistance to an air flow passing the plate.

Preferably, the first angle is in a range of from 3 to 87 degrees, more preferably, in a range of from 6 to 60 degrees, and still more preferably in a range of from 9 to 30 degrees.

The assembly may further include a second plate with at least a second light emitting source thereon for emission of light, wherein when in use, the second plate extends at a second angle to a substantially horizontal direction. When in use, the pair of plates are preferably substantially symmetric about a substantially vertical axis.

Preferably, at least one of the first and second plates is formed from reflective material.

When in use, at least one of the first and second light emitting sources may be positioned to be distanced from at least the center of the light from the other light source onto the corresponding plate where said at least one of the first and second light emitting sources is located.

Each plate preferably has a plurality of light sources thereon, and wherein the light sources on one of the plates are offset relative to those on the other plate. Preferably, at least one of the first and second plates is formed from a reflective material.

The first and second plates are preferably connected to each other at one end.

The assembly preferably further includes a passage between a pair of opposed ends of the first and second plates to allow air flow therethrough for dissipation of heat generated by the light emitting sources.

Preferably, the first and second plates extend at an angle of more than 0 degree and less than 180 degrees relative to each other for forming the air passage therebetween.

Preferably, the first and second plates are connected to each other at one of their side surfaces such that the assembly exhibits a frustum shape.

Preferably, the air passage passes from an end of the frustum to its opposed end.

Preferably, the second angle is in a range of from 3 to 87 degrees, more preferably, in a range of from 6 to 60 degrees, and still more preferably in a range of from 9 to 30 degrees.

In a further aspect, the present invention provides a light emission assembly comprising:
at least one pair of substrates wherein at least one substrate carries thereon at least first light source;
   wherein the substrates converge in a manner so as to define a ventilation pathway therebetween and in a manner such that air flow adjacent and between the substrates is promoted so as to provide heat dissipation from the light source.

Preferably the first light source is located on the surface of the substrate within the ventilation pathway, and at least a portion of the other substrate opposing the light source includes a light reflective portion for reflecting light from the ventilation pathway.

Preferably heat emitted from the light source promotes air flow through the ventilation pathways.

At least one further light source is preferably carried by the other substrate opposing the first light source.

Preferably at least a portion of the substrate opposing the further light source includes a light reflective portion for reflecting light from the ventilation pathway.

A plurality of light sources is preferably provided on each of the substrates. Preferably the light sources of the substrates are arranged in an offset relationship with respect to each other. More preferably the light sources of the substrates are arranged in a staggered relationship with respect to each other.

The included angle between the substrates is preferably in the range of from 5 to 170 degrees, more preferably in the range of from 12 to 120 degrees and still more preferably in the range of from 18 to 60 degrees.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

The invention now will be described, by way of example only, and with reference to the accompanying drawings in which:

FIG. 1 shows a cross-sectional view of a light emitting assembly in the prior art;

FIG. 2a shows a cross-sectional view of a first embodiment of a ceiling light emitting assembly according to the present invention;

FIG. 2b shows a cross-sectional view of a second embodiment of a ceiling light emitting assembly according to the present invention;

FIG. 3a shows a perspective view of a third embodiment of a ceiling light emitting assembly according to the present invention;

FIG. 3b shows a front view of the light emitting assembly of FIG. 3a;

FIG. 3c shows a side-projection view of the light emitting assembly of FIG. 3a

FIG. 3d shows a cross sectional view of the light emitting assembly of FIG. 3a along line A-A′;

FIG. 3e shows a cross sectional view of the light emitting assembly of FIG. 3a along line B-B′;

FIG. 4 shows a cross-sectional view of a fourth embodiment of a ceiling light emitting assembly according to the present invention;

FIG. 5 shows a cross-sectional view of a fifth embodiment of a ceiling light emitting assembly according to the present invention;

FIG. 6 shows a cross-sectional view of a sixth embodiment of a ceiling light emitting assembly according to the present invention.

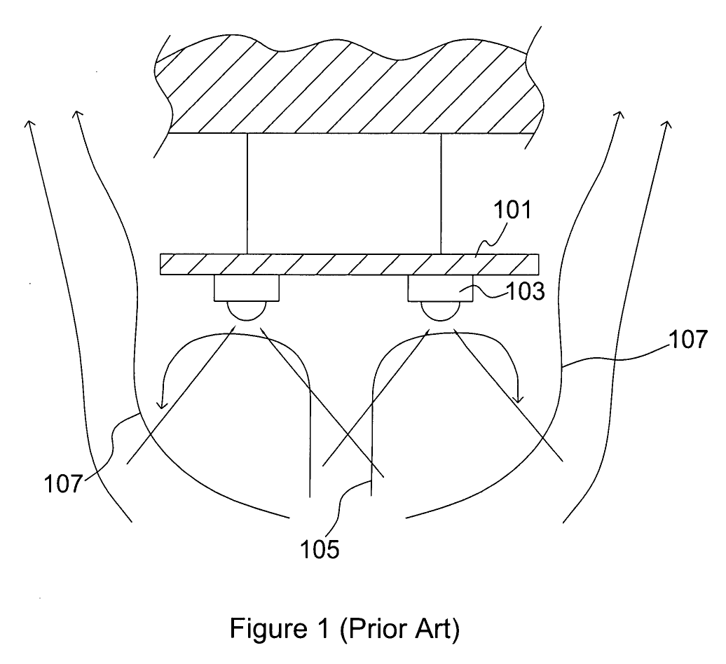

### DETAILED DESCRIPTION

The following description refers to exemplary embodiments of a ceiling light emitting assembly of the present invention. Reference is made in the description to the accompanying drawings whereby the light emitting assembly is illustrated in the exemplary embodiments. Similar components between the drawings are identified by the same reference numerals.

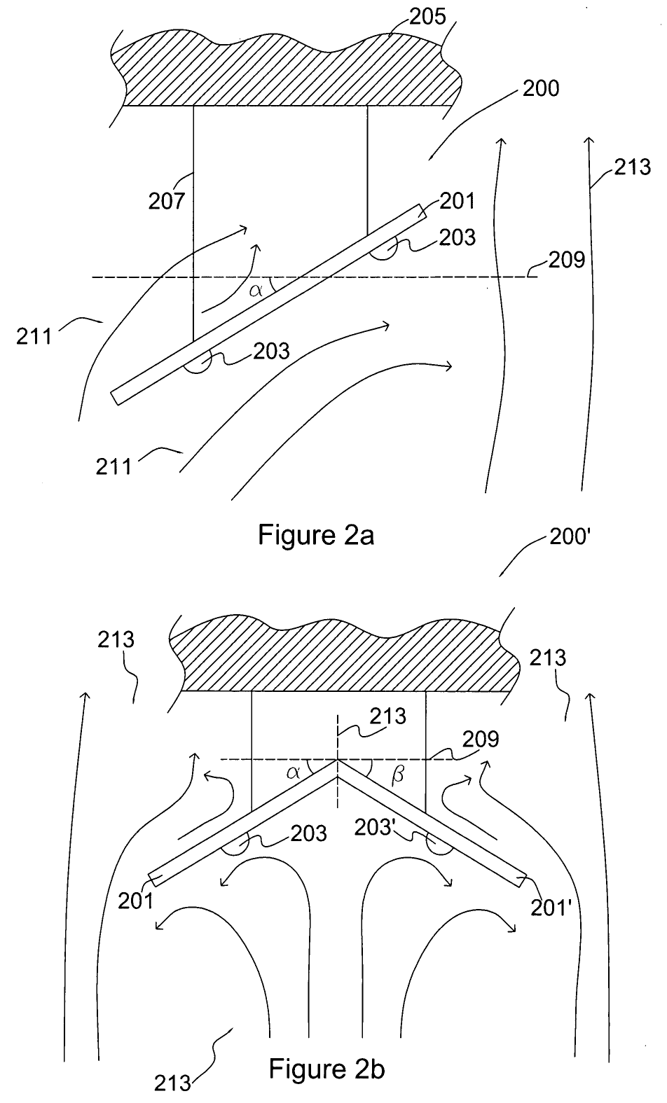

FIG. 2a illustrates a first embodiment of a ceiling light emitting assembly 200 according to the present invention, including a substantially planar substrate 201 with a plurality of light emitting sources 203, for example, light emitting diodes (LEDs), lamps, or the like, thereon for emission of light. The plate 201 is attached to the ceiling 205 of a building through a pair of ropes 207 of other similar mechanisms. Furthermore, the plate is tilted at an angle α to the horizontal direction generally indicated by reference number 209. Angle α is approximately 10 degrees in the exemplary embodiment, but can be in a range of 3-87 degrees, preferably in a range of 6-60 degrees, and more preferably in a range of 9-30 degrees, as could be appreciated by a skilled person in the art.

By having the plate 201 tilted at an angle to the horizontal direction, resistance to the air flow 211 passing the plate 201 can be reduced due to the relatively less abrupt momentum change along the vertical or gravity direction 213 as could be appreciated by a skilled person in the art. In this way, the efficiency of heat dissipation from such the plate and/or the LEDs through natural convection thereon will be improved.

FIG. 2b illustrates a second embodiment of a ceiling light emitting assembly 200′ according to the present invention, including a pair of plates 201, 201′ with LEDs 203, 203′ thereon. The plates 201, 201′ are connected at one end. Furthermore, each plate is tilted at an angle α, β to the horizontal direction 209, with angle α, β approximately 10 degrees in the exemplary embodiment, but can be in a range of 3-87 degrees, preferably in a range of 6-60 degrees, and more preferably in a range of 9-30 degrees, as could be appreciated by a skilled person in the art. In addition, the plates 201, 201′ are substantially symmetric about a vertical axis 213. Air flow passing through the plates for heat dissipation purpose is shown in FIG. 2b as indicated by reference number 213. A skilled person can appreciate that the air flow resistance exerted by the plate(s) will be reduced such that the efficiency of heat dissipation can be improved.

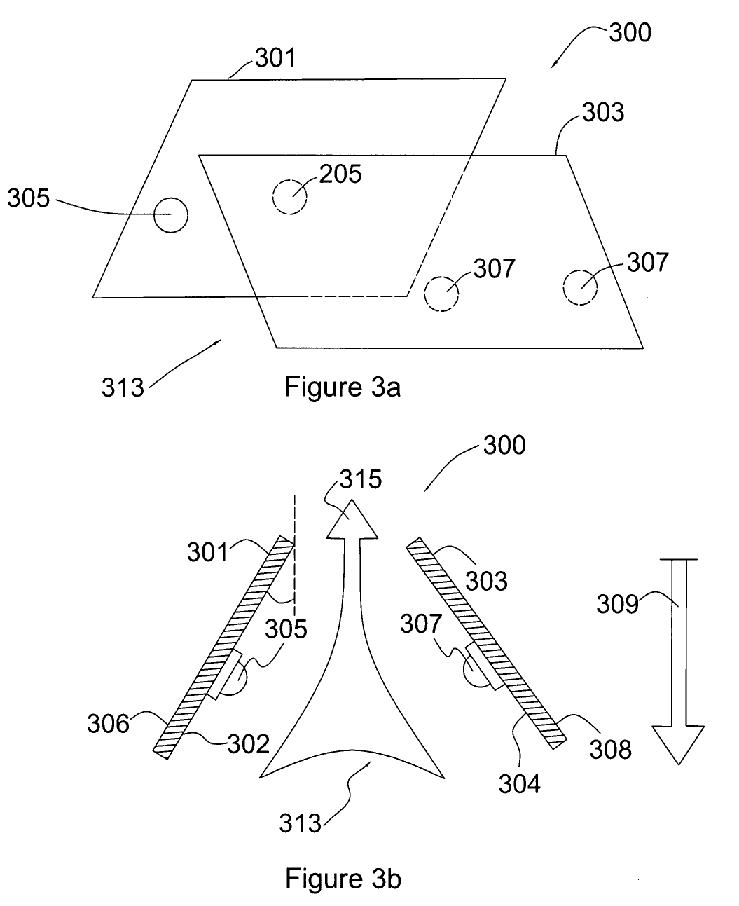

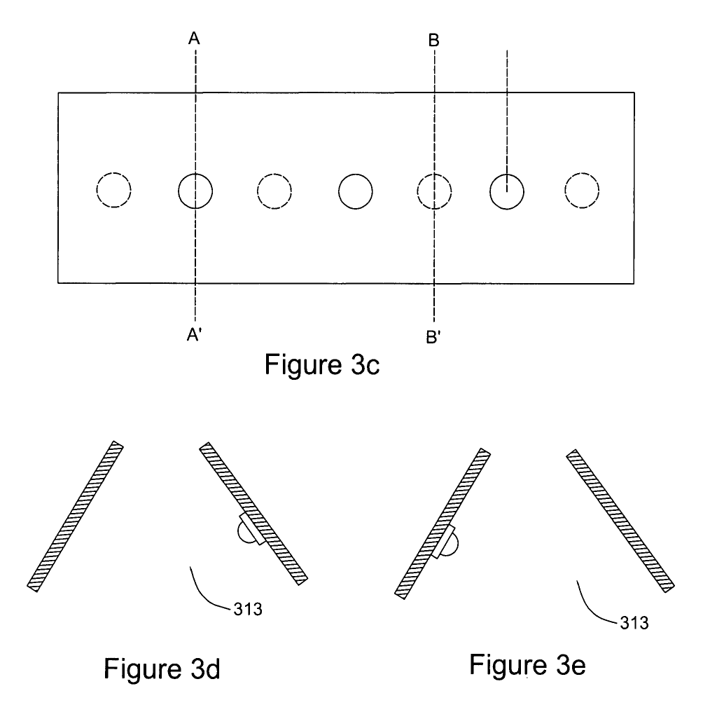

As shown in FIGS. 3a and 3b, a third embodiment of a ceiling light emitting assembly 300 of the present invention includes a first and a second substantially elongate plates 301, 303, each having a top surface 302, 304 and an opposed bottom surface 306, 308, with a plurality of light emitting sources 305, 307, for example, light emitting diodes, lamps, or the like, provided on its top surface 302, 304 for emission of light in a primary light emission direction indicated by arrow 309. Furthermore, the first and second plates 301, 303 are spaced apart and extend at an angle to each other such that an air passage 313 is formed between the two opposed top surfaces 302, 304 of the plates 301, 303, to allow air flow therethrough, as indicated by arrow 315, for dissipation of heat generated by the light emitting sources 301.

A skilled person in the art will appreciate that the tilted plates may reduce the air flow resistance to the air flow passing the plates. Further, by providing an air passage between the two plates, an air flow can pass therethrough to enhance the heat dissipation from the light sources and or the plates to the ambient air through natural convection such that the efficiency of heat dissipation can be improved.

In the exemplary embodiment, the first and second plates 301, 303 extend at an angle more than 0 degree but less than 180 degrees, preferably in a range of 30 to 150 degrees, relative to each other for forming the air passage 313 therebetween and preferably are substantially symmetric about a center axis, not shown in the figures, substantially parallel to the primary light emission direction 309.

In the exemplary embodiment, each plate 301, 303 is formed from reflective material such as metal, and each light emitting source 305 on the first plate 301 is positioned to be substantially away from at least the center of the light emitted from the light emitting sources 307 of the second plate 303 onto the first plate 301 such that the light emitting sources 305 on the first plate 301 do not block the reflection of the light emitted from the light emitting source 307 of the second plate 303 onto the opposed first plate 301, preferably substantially in the primary light emission direction, so as to enhance the optical output of the assembly 300, and vice versa.

For example, as exemplified in FIG. 3c, the light emitting sources 305 on the first plate 301 are staggered or offset with respect to those on the second plate 303, that is, if all the light emitting sources are projected onto a plain substantially parallel to the primary light emission direction 309, each light emitting source is positioned such that its projection is substantially away from the center of those of the other light emitting sources. In this way, a plurality of reflective mirrors are formed on each plate, each mirror opposing a corresponding light emitting source on the opposed plate for reflecting the light therefrom.

Preferably, the light emitting sources are positioned such that there is only one light emitting source in a cross-section of the light emitting assembly 300 as shown in FIGS. 2d and 2e. An ordinarily skilled person in the art will appreciate that such an exemplary embodiment can have an improved thermal dissipation performance by minimizing the number of heat resources within a certain area.

In addition, each plate 301, 303 is preferred to be formed from thermally conductive material.

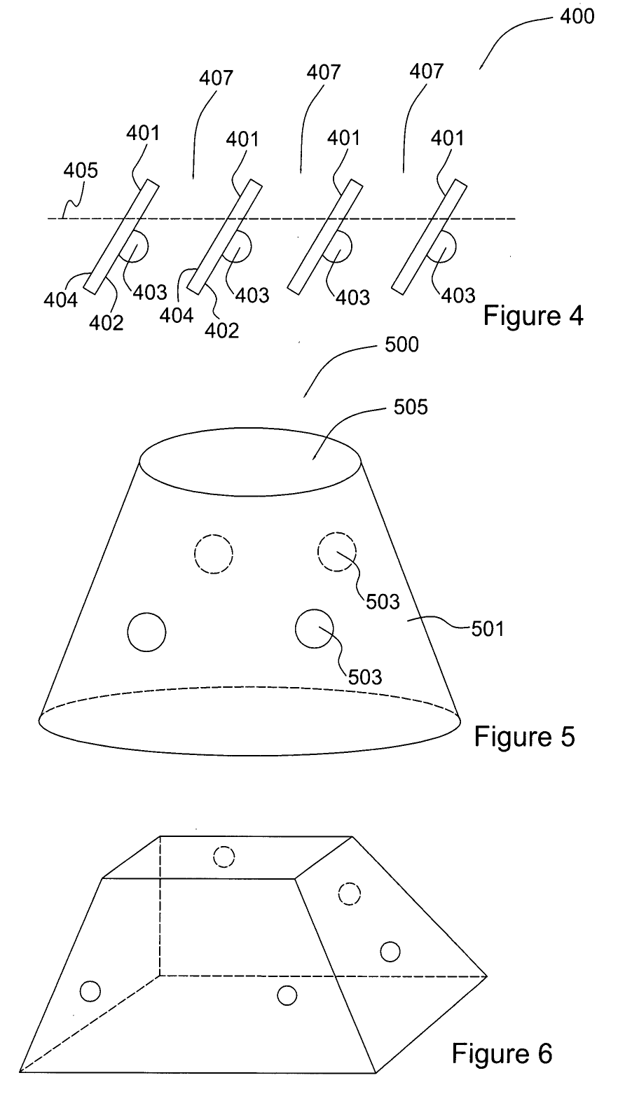

In FIG. 4, a fourth embodiment of a ceiling light emitting assembly 400 of the present invention includes a plurality of substantially elongate plates 401 arranged substantially along an elongate axis 405. Each plate 401 has an upper surface 402 and an opposed lower surface 404, with a plurality of light emitting sources 403 provided on its top surface 402 for emission of light. Furthermore, each plate 401 is tilted at an angle with respect to the axis 405 for forming an air passage 407 between each pair of adjacent plates 401, in particular, between a lower surface of one of the pair of adjacent plates and an opposed upper surface of the other plate, to allow air flow therethrough for dissipation of heat generated by the light emitting sources 403.

In FIG. 5, a fifth embodiment of a light emitting assembly 500 of the present invention includes a conical frustum shaped plate 501, which can actually be considered as two curved plates joined at their side surfaces, and a plurality of light emitting sources 503 provided on the inner surface of the plate 501. An air passage 505 is formed in the interior defined by the conical frustum shaped plate 501, extending from a bottom of the frustum to its top.

FIG. 6 illustrates a sixth embodiment of the present invention similar to the third embodiment but exhibiting a pyramid frustum shape.

It will be understood that the invention disclosed and defined herein extends to all alternative combinations of two or more of the individual features mentioned or evident from the text or drawings. All of these different combinations constitute various alternative aspects of the invention. The foregoing describes an embodiment of the present invention and modifications, apparent to those skilled in the art can be made thereto, without departing from the scope of the present invention.

Although the invention is illustrated and described herein as embodied, it is nevertheless not intended to be limited to the details described, since various modifications and structural changes may be made therein without departing from the spirit of the invention and within the scope and range of equivalents of the claims.

Furthermore, it will be appreciated and understood that the words used in this specification to describe the present invention and its various embodiments are to be understood not only in the sense of their commonly defined meanings, but also to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result, without departing from the scope of the invention.

What is claimed is:

1. A ceiling light emitting assembly comprising
a first plate having at least a first light emitting source thereon for emission of light,
wherein when in use, the first plate extends at a first angle to a substantially horizontal direction for reducing resistance to an air flow passing the plate.

2. The assembly of claim 1, wherein the first angle is in a range of from 3 to 87 degrees.

3. The assembly of claim 2, wherein the first angle is in a range of from 6 to 60 degrees.

4. The assembly of claim 3, wherein the first angle is in a range of from 9 to 30 degrees.

5. The assembly of claim 1, further comprising a second plate with at least a second light emitting source thereon for emission of light, wherein when in use, the second plate extends at a second angle to a substantially horizontal direction.

6. The assembly of claim 5, wherein when in use, the pair of plates are substantially symmetric about a substantially vertical axis.

7. The assembly of claim 5, wherein at least one of the first and second plates is formed from reflective material.

8. The assembly of claim 5, wherein when in use, at least one of the first and second light emitting sources is positioned to be distanced from at least the center of the light from the other light source onto the corresponding plate where said at least one of the first and second light emitting sources is located.

9. The assembly of claim 8, wherein each plate has a plurality of light sources thereon, and wherein the light sources on one of the plates are offset relative to those on the other plate.

10. The assembly of claim 8, wherein at least one of the first and second plates is formed from a reflective material.

11. The assembly of claim 5, wherein the first and second plates are connected to each other at one end.

12. The assembly of claim 5, further comprising a passage between a pair of opposed ends of the first and second plates to allow air flow therethrough for dissipation of heat generated by the light emitting sources.

13. The assembly of claim 12, wherein the first and second plates extend at an angle of more than 0 degree and less than 180 degrees relative to each other for forming the air passage therebetween.

14. The assembly of claim 12 wherein the first and second plates are connected to each other at one of their side surfaces such that the assembly exhibits a frustum shape.

15. The assembly of claim 11, wherein the air passage passes from an end of the frustum to its opposed end.

16. The assembly of claim 5, wherein the second angle is in a range of from 3 to 87 degrees.

17. The assembly of claim 16, wherein the second angle is in a range of from 6 to 60 degrees.

18. The assembly of claim 17, wherein the second angle is in a range of from 9 to 30 degrees.

19. A light emission assembly comprising:
at least one pair of substrates wherein at least one substrate carries thereon at least first light source;
wherein the substrates converge in a manner so as to define a ventilation pathway therebetween and in a manner such that air flow adjacent and between the substrates is promoted so as to provide heat dissipation from the light source.

20. A light emission assembly according to claim 19, wherein the first light source is located on the surface of the substrate within the ventilation pathway, and at least a portion of the other substrate opposing the light source includes a light reflective portion for reflecting light from the ventilation pathway.

21. A light emission assembly according to claim 19 or claim 21, wherein heat emitted from the light source promotes air flow through the ventilation pathways.

22. A light emission assembly according to any one of claims 19 to 21, wherein at least one further light source is carried by the other substrate opposing the first light source.

23. A light emission assembly according to claim 20, wherein and at least a portion of the substrate opposing the further light source includes a light reflective portion for reflecting light from the ventilation pathway.

24. A light emission assembly according to claim 22 or claim 23, wherein a plurality of light sources is provided on each of the substrates.

25. A light emission assembly according to claim 24, wherein the light sources of the substrates are arranged in an offset relationship with respect to each other.

26. A light emission assembly according to claim 25, wherein the light sources of the substrates are arranged in a staggered relationship with respect to each other.

27. A light emission assembly according to any one of claims 19 to 26, wherein the included angle between the substrates is in the range of from 5 to 170 degrees.

28. A light emission assembly according to any one of claims 19 to 27, wherein the included angle between the substrates is in the range of from 12 to 120 degrees.

29. A light emission assembly according to any one of claims 19 to 28, wherein the included angle between the substrates is in the range of from 18 to 60 degrees.
